(19) United States
(12) Patent Application Publication
(10) Pub. No.: US 2025/0385573 A1
(43) Pub. Date: Dec. 18, 2025

(54) METHOD FOR MONITORING AND CONTROLLING THE COOLANT TEMPERATURE OF A DRIVE DEVICE OF A SEPARATOR

(71) Applicant: GEA WESTFALIA SEPARATOR GROUP GMBH, Oelde (DE)

(72) Inventors: Andrej MICHEL, Ennigerloh (DE); Dennis NEUFELD, Oelde (DE); Jürgen TEIGELER, Oelde (DE)

(21) Appl. No.: 18/878,164

(22) PCT Filed: Jul. 10, 2023
(86) PCT No.: PCT/EP2023/069000

§ 371 Date: Dec. 23, 2024

(30) Foreign Application Priority Data
Jul. 12, 2022 (DE) 10 2022 117 310.0

(51) Int. Cl. H02K 9/19; B04B 9/02; B04B 15/02

(52) U.S. Cl. CPC H02K 9/19; B04B 9/02; B04B 15/02

(57) ABSTRACT

The coolant temperature of an electric motor of a drive device of a rotor of a centrifuge is controlled by supplying the electric motor with a coolant. The rotor is driven during execution of the centrifugal separation of a suspension into at least two different product phases and the electric motor is cooling, in a controlled manner while the rotor is driven in cooling cycles interrupted by breaks.

### BACKGROUND AND SUMMARY OF THE INVENTION

Exemplary embodiments of the invention relate to a method for controlling the coolant temperature of an electric motor of a drive device of a rotor of a centrifuge.

In order to achieve a compact design for centrifugal separators of this generic type, the drives of these separators are equipped with an integrated, water-cooled electric motor for direct drive of the rotor with the separator drum.

It is known to provide the coolant in the required quantity and within the permissible temperature range for cooling the electric motor in accordance with the electric motor manufacturer's specifications. In this way, the maximum permissible motor temperature can be maintained. The required supply quantity is limited, for example, by a corresponding orifice or a needle valve.

An additional opening valve opens the coolant supply when the electric motor is running and closes it as soon as the electric motor is switched off. The opening valve for the coolant is permanently open during operation of the drive motor and the coolant flows through the drive motor at a flow rate specified by the electric motor manufacturer.

With this approach, the coolant consumption is always constantly the same, regardless of the load on the drive motor (product throughput and emptying frequency and size) and the actual temperature of the incoming coolant. Prior art solutions have therefore been developed to solve this problem.

DE 38 09 149 C1 describes how the cross-section of the coolant drain line can be changed in stages depending on the coolant drain temperature of a drive unit (engine).

DE 20 2007 004 983 U1 describes the use of a water-cooling system as a circuit arrangement for cooling centrifuge drives, which results in the need for a circulation pump and a heat exchanger.

EP 00 16 584 A1 describes the use of water cooling, which is fed to a heat exchanger, to cool centrifuge drives.

The concepts for cooling electric motors of separators according to the prior art have proven themselves in practice. The disadvantage of these concepts is that the coolant consumption is still quite high.

A method is provided for controlling the coolant temperature of an electric motor of a drive device of a rotor of a centrifuge, in particular a separator with a vertical axis of rotation, in particular during execution of a centrifugal separation of a suspension into at least two different product phases; wherein the rotor of the centrifuge has at least one rotatable drum, and wherein the drive device has an electric motor that directly or indirectly rotates the rotor, and wherein the drive device further has an apparatus for supplying the electric motor with a coolant, which comprises a control apparatus, wherein the method comprises at least the following steps of:
a) providing the centrifuge with the drive device;
b) driving the rotor with the electric motor, in particular during execution of the centrifugal separation of a suspension into at least two different product phases, and
c) controlled cooling of the electric motor at least during step b) for a limited cooling phase in cycles interrupted by breaks.

It can also preferably be provided that the length of the cooling phase of a respective cycle is calculated by the control apparatus taking into account one or more measured values, wherein the at least one measured value or the several measured values can be measured temperature values.

Cooling in cycles generally significantly reduces coolant consumption compared to continuous cooling. In a cooling system that is set up as a circuit, it is possible to work with a reduced coolant volume per time or less coolant is moved in the circuit.

According to a particularly advantageous variant, the cycles of step c) comprise the following sub-steps of:
c1) opening an opening valve of the coolant supply system to generate a flow of coolant through a cooling fluid system of the electric motor, which has at least one coolant supply line and one coolant discharge line as well as a motor coolant passage;
c2) measuring an instantaneous temperature of the coolant Tᵢₙₛₜ after a predetermined time tₘₑₐₛ has elapsed at the coolant discharge line by a temperature measuring device and transmission of the measured value for Tᵢₙₛₜ to a control apparatus, wherein the predetermined time tₘₑₐₛ is determined as a function of a length of the coolant discharge line between the electric motor and the temperature measuring device;
c3) comparing the measured value of Tᵢₙₛₜ with an upper limit value of the coolant temperature Tₗᵢₘᵢₜ;
c4) calculating a time t_{cool} by the control apparatus as a function of Tᵢₙₛₜ, during which the opening valve also remains open;
c5) closing the opening valve after tₘₑₐₛ and t_{cool} have elapsed for a cycle pause time tₚₐᵤₛₑ;
whereupon the method steps c1) to c5) are run through again virtually endlessly in the manner of a program loop after tₚₐᵤₛₑ has elapsed until the drive motor of the centrifuge stops operating.

This results in the following total cycle time: t_{cycle}=tₘₑₐₛ+t_{cool}+tₚₐᵤₛₑ

This creates a method for monitoring and controlling the coolant temperature of a centrifuge, in which the instantaneous coolant temperature can be kept as constant as possible at a defined upper coolant temperature limit. In this way, the electric motor of the separator is operated at the maximum permissible temperature and the lowest possible coolant consumption, regardless of its load, the ambient temperature and the temperature of the incoming coolant.

A further advantage of the method according to the invention or a separator with a correspondingly equipped control apparatus is that it can be easily retrofitted to existing coolant-cooled electric motors, as basically only the temperature measuring device on the coolant discharge line needs to be added on the hardware side. A temperature sensor inside the electric motor is not required, although it may be provided. In addition, only a simple valve with two switching positions (“open” and “closed”) is required as an opening valve. Therefore, no control valve or controllable iris diaphragm is required, nor are several valves and lines, as in prior art solutions.

A computer program product is also stored and executed on the control apparatus or other memory connected or connectable thereto, comprising instructions which cause the method steps of the method for cooling the electric motor in cycles to be executed on the separator for cooling the drive device.

According to a particularly preferred embodiment variant of the invention, it is provided that the opening valve is closed immediately after the time period tₘₑₐₛ when the instantaneous coolant temperature Tᵢₙₛₜ is below an upper limit value of the coolant temperature Tₗᵢₘᵢₜ. This allows the coolant to absorb thermal energy up to a defined upper limit temperature for the coolant, whereby the required coolant volume flow can be advantageously reduced.

According to a further particularly preferred embodiment variant of the invention, it is provided that the opening valve remains open for a further time t_{cool} if the instantaneous coolant temperature Tᵢₙₛₜ is greater than or equal to the upper limit value of the coolant temperature Tₗᵢₘᵢₜ. As a result, an increased coolant temperature is lowered to a defined upper limit temperature for the coolant, while at the same time advantageously minimizing the coolant volume flow required for this.

Furthermore, according to a further particularly preferred embodiment variant of the invention, it may be provided that a correlation table of the measured values of Tᵢₙₛₜ and t_{cool} is determined experimentally, resulting in a centrifuge-specific or coolant supply system-specific characteristic curve which represents the relationship between Tᵢₙₛₜ and t_{cool}, so that a coolant temperature control is designed as a type of characteristic curve control. This results in an advantageously simple operating principle for coolant control, which can be individually adapted to the respective separator.

Alternatively, according to a further particularly preferred embodiment variant of the invention, it may be provided that in step c) one or more measured values of the instantaneous coolant temperature Tᵢₙₛₜ, and preferably additionally one or more measured values of the ambient temperature and one or more instantaneous motor load characteristic values, are supplied to the control apparatus—in particular to a higher-level control device of the separator—whereupon the control apparatus determines a cooling time t_{cool} with the aid of these measured values according to an algorithm. If the coolant temperature does not change in the desired direction after several subsequent cooling cycles, the algorithm is adapted by the control apparatus, preferably by the higher-level control device, until the coolant temperature is set to the value Tₗᵢₘᵢₜ. This adaptability of the algorithm means that the control system can adapt particularly well to changing operating conditions.

Alternatively, according to a further particularly preferred embodiment variant of the invention, it may be provided that a PID controller can be used as the control apparatus. This allows the coolant temperature to be monitored and controlled in a particularly flexible manner.

The invention can be used constructively in various cooling system variants.

Likewise, according to a further particularly preferred embodiment variant of the invention, it may be provided that the coolant supply system is designed according to the principle of a closed coolant circuit.

According to a further particularly preferred embodiment variant of the invention, it is provided that the coolant is pumped in the circuit with the aid of a pump and cooled with a heat exchanger and the required cooling capacity is supplied to the heat exchanger via a refrigeration circuit.

Furthermore, according to another particularly preferred embodiment variant, it may be provided that the coolant can be taken from a storage tank and pumped back into the storage tank after flowing through the electric motor and absorbing heat. This creates an open circuit to which coolant can be added or removed as required. This is advantageous for short peak loads, for example. Coolant consumption is also effectively minimized with this variant.

In this context, according to a further preferred embodiment variant, it may be provided that the heat absorbed by the coolant is released back to the surroundings of the storage tank by convection via a wall of the storage tank. This effectively minimizes a possible coolant refill volume, thereby advantageously saving coolant.

It is particularly advantageous if the wall of the storage tank is equipped with suitable means to improve convective heat dissipation. This further effectively minimizes any possible coolant refill volume, thereby saving coolant.

The invention also provides a separator comprising a control apparatus and other means adapted to perform the steps of the method of one of the preceding claims. It also provides a computer program product comprising commands or instructions which cause the separator to perform the method steps. A computer readable medium is also created on which the computer program is stored.

### BRIEF DESCRIPTION OF THE DRAWING FIGURES

In the following, the invention is described in more detail with reference to the drawing by means of exemplary embodiments. The invention is not limited to these exemplary embodiments, but can also be realized in other ways according to the wording or in other equivalent ways, wherein:

FIG. 1 shows a schematic sectional view of a separator with a coolant supply system for the drive motor;

FIG. 2 shows a simplified circuit diagram of a coolant supply system for a separator;

FIG. 3 shows an embodiment variant of the coolant supply system from FIG. 2;

FIG. 4 shows a further embodiment variant of the coolant supply system shown in FIG. 2; and

FIG. 5 shows a flow chart illustrating an exemplary method according to the invention; and

FIG. 6 shows a further flow diagram illustrating sub-steps from FIG. 5.

Several exemplary embodiments are described in the following description of the figures. The individual features of these exemplary embodiments can also be combined with exemplary embodiments not shown and are also suitable in each case as advantageous designs of the objects described in one or more of the main and sub-claims.

### DETAILED DESCRIPTION

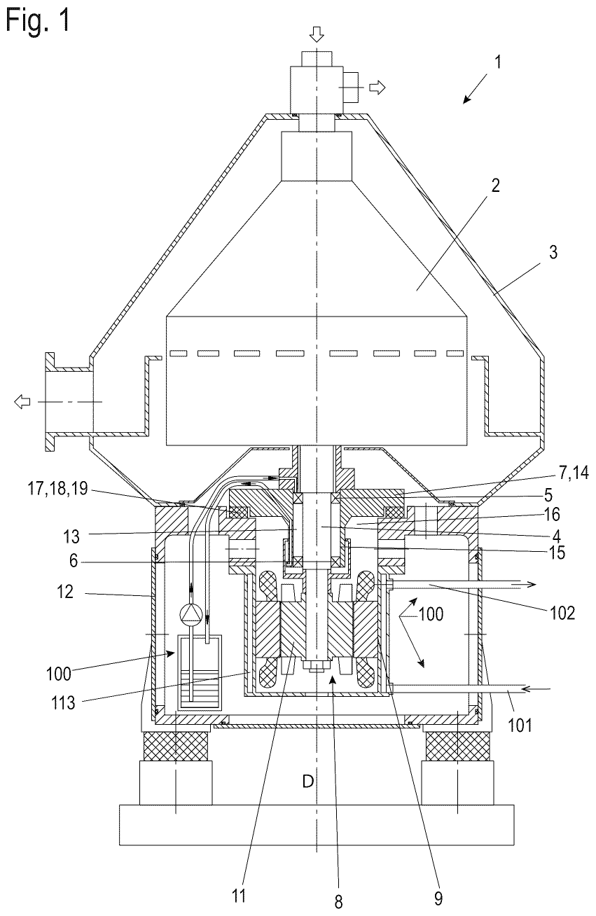

FIG. 1 shows a centrifuge, which can be designed as a separator 1. The centrifuge—in this case the separator—has a rotor. This rotor comprises a rotatable drum 2 with a vertical axis of rotation D in this case. This drum 2 can be surrounded by a hood arrangement 3. Terms such as “top” and “bottom” below refer to the exemplary vertical arrangement of the drum 2. The drum 2 is mounted on a drive spindle 4. This is rotatably mounted in a bearing housing 7 by a bearing arrangement, which here comprises an upper bearing 5 and a lower bearing 6. As an example, this bearing arrangement has two roller bearings. Other designs are conceivable (not shown here).

The drive of the separator has an electric motor 8 for rotating the rotor with the drum 2. This electric motor 8 has an electric motor housing 9 with a stator 10 or stator winding and a motor rotor or rotor 11.

The electric motor 8 advantageously does not have its own bearing, which enables a more cost-effective design. Instead, the bearing arrangement is arranged here between the electric motor 8 and the drum 2 as an example. However, the bearing arrangement can also be realized in other ways.

The drive spindle 4 can also be connected directly—i.e., preferably without intermediate elements such as a coupling—to the rotor 11. The electric motor housing 9 with the stator 10, on the other hand, can be arranged rigidly and unsprung on the machine frame 12 of the separator 1 or supported on it.

In this way, the drum 2 with the drive spindle 4, the rotor 11 and the bearing housing 7 form an oscillating unit that is elastically supported on the machine frame 12, but to which the stator 10 does not belong, so that relative movements occur between the rotor 11 and the stator 10.

The drive spindle 4 is arranged in a bore-like opening 13 of the single-part or multi-part bearing housing 7 by means of the bearing 5 and the bearing 6.

The bearing housing 7 has an upper flange 14 and a lower sleeve-like section 15, which extends through an opening 16 in the machine frame 12.

The upper flange 14 is supported on the machine frame 12 via circumferentially distributed elastic damping elements 17, which are distributed between the underside of the flange 14 and the upper side of the machine frame 12, wherein the flange 14 and the machine frame 12 are provided with ring-like steps 18, 19 in the area of the damping elements 17.

Furthermore, a lubricant supply 20 can be provided to supply the bearings 5, 6 with lubricant.

In this respect, the present description relates to an advantageous exemplary embodiment, but is not limited to this design. Rather, the coolant supply system described below and the associated methods can be used with the separator described above, but also with separators of a different design.

A centrifuge according to the invention—designed, for example, like the separator of FIG. 1—has a coolant supply system 100, which supplies the drive or, in this case, its electric motor 8 with coolant. The coolant can be a fluid, in particular water. Other suitable fluids can also be used as coolants. The coolant supply system 100 has at least one coolant supply line 101—also known as the coolant feed line—and one coolant discharge line 102—also known as the coolant return line. A motor coolant passage 113 is arranged between the coolant supply line and the coolant discharge line, which can be routed through and/or past elements of the electric motor. This is where the actual cooling of the electric motor 8 takes place, in particular the stator, which heats the coolant in this section. The coolant supply system 100 can have further elements, such as one or more controllable valves.

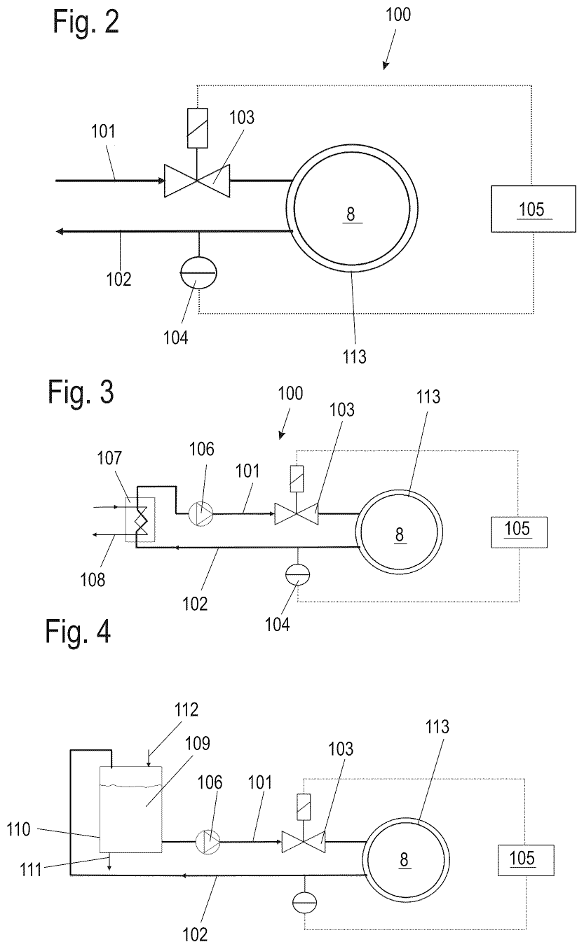

In FIG. 2, elements of an exemplary coolant supply system 100 of a separator—e.g., the separator 1 of FIG. 1—are shown in particular. The coolant supply system 100 here again has the coolant supply line 101, the motor coolant passage 113, and the coolant discharge line 102, each of which is connected to the electric motor. A controllable opening valve 103 can be provided in the coolant supply line 101. The opening valve 103 is designed to be controllable. It can preferably be opened and closed by an electric or electromagnetic actuator controlled by a control apparatus 105. Alternatively, the opening valve 103 can also be actuated by other means.

The coolant discharge line 102 of the exemplary embodiment of FIG. 2 then has a temperature measuring device 104. The temperature measuring device 104 can, for example, be designed as a resistance temperature sensor. The temperature measuring device 104 can also be designed in another way. The coolant supply system 100 further comprises a control apparatus 105. The control apparatus 105 can be designed as an independent control apparatus that only controls the coolant. Alternatively, it can also be integrated into a higher-level control device of the separator. It is designed to receive measured values from the temperature measuring device 104. The temperature measuring device 104 is connected to the control apparatus 105 so that it can process the measured values recorded. The control apparatus 105 is also designed to control actuators, such as the valve 103 in particular, directly or via intermediate control means in the manner of a control device.

The control apparatus 105 can have a microprocessor and interfaces, as well as further intermediate control means such as a gateway and components connected downstream thereto, with the aid of which it can be connected at least to the controllable actuators such as the opening valve 103 and to one or more sensors such as the temperature measuring device 104. This connection can be made via a wired or non-wired data transmission path.

The method described below is proposed for monitoring and controlling the coolant temperature of the separator drive 1. This is used to actively control the metering of the coolant flow rate through the electric motor 8 of the separator drive.

For this purpose, it can be advantageously and simply provided that the control apparatus 105 opens and closes the opening valve 103 in pulses in cooling cycles during operation of the separator or during operation of the drive with the electric motor 8 used as the drive, wherein the duration of the opening pulse is dependent on the measured temperature of the coolant Tᵢₙₛₜ at the coolant discharge line 102 of the electric motor, which is measured by the temperature measuring device 104. This procedure results in very low coolant consumption. In this way, it is often possible to achieve a reduction in coolant consumption compared to the specifications of the electric motor manufacturer and, for example, to reduce water consumption in the long term.

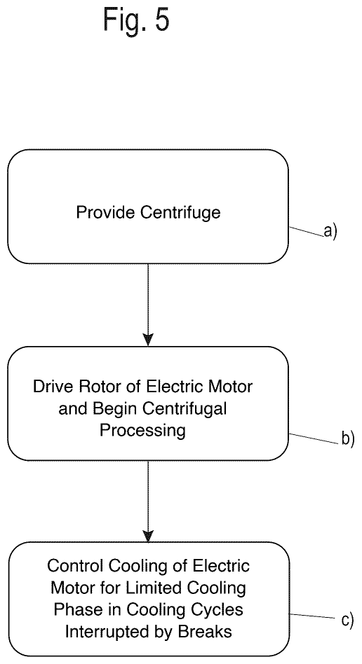

First, the centrifuge is provided (with its drive) and the rotor is set in rotation with the electric motor 8 and centrifugal processing is started (FIG. 5—steps a, b).

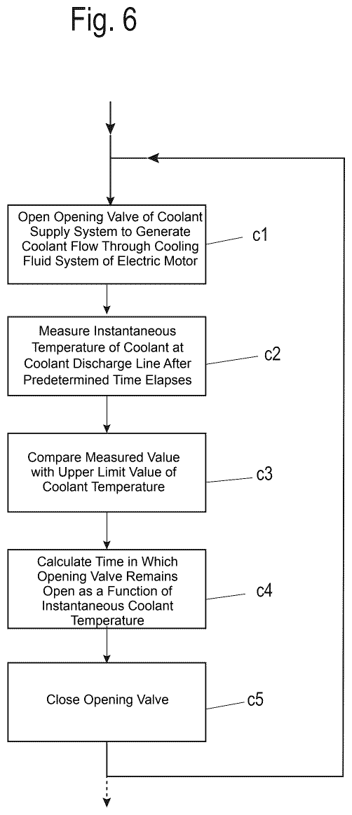

During the rotation (from the beginning) of the rotor, cooling also starts in parallel in cycles (FIG. 5 step c), wherein the sub-steps of this step c) can then be repeated during the centrifugal separation (see FIG. 6).

At the beginning of each cooling cycle of the electric motor 8, which is in operation in particular during centrifugal separation and which rotates the drive spindle 4 of the separator 1, the opening valve 103 for the coolant supply to the drive motor is opened for a defined period of time tₘₑₐₛ (FIG. 6—step c1), whereby the heated coolant is pressed out of the motor coolant passage 113 (e.g., a cooling jacket of the electric motor 8) into the coolant discharge line 102, in which the temperature measuring device 104 is also located. This measures the instantaneous coolant temperature Tᵢₙₛₜ after the time tₘₑₐₛ has elapsed and transmits this measured value to the control apparatus 105. In order to ensure that the coolant temperature is recorded correctly, the time tₘₑₐₛ can be suitably selected as a function of a length of the coolant discharge line 102 between the electric motor and the temperature measuring device 104 according to empirical values from previous cycles or other measured values from comparable centrifuges. Depending on Tᵢₙₛₜ, the control apparatus 105 calculates the additional time t_{cool} for which the opening valve 103 remains open.

If the measured value of Tᵢₙₛₜ is below an upper limit value of the coolant temperature Tₗᵢₘᵢₜ (e.g. 40° C.), the opening valve 103 can be closed again immediately after the period tₘₑₐₛ.

If the measured value of Tᵢₙₛₜ is above the upper limit value of the coolant temperature Tₗᵢₘᵢₜ, the opening valve 103 is opened further for the time t_{cool}.

A value or allocation table of the measured values of Tᵢₙₛₜ and t_{cool} can be determined experimentally. This results in a characteristic curve specific to the centrifuge or coolant supply system, which represents the relationship between Tᵢₙₛₜ and t_{cool}, so that the coolant temperature control is designed as a type of characteristic curve control.

Alternatively, the control apparatus 105 can be supplied with the measured values of the instantaneous coolant temperature, optionally the ambient temperature and optionally the engine load. The control apparatus feeds these measured values to a suitable algorithm, which determines a cooling time t_{cool}. If the coolant temperature does not change in the desired direction after several subsequent cooling cycles, the algorithm is adapted by the control apparatus until the coolant temperature is set to the value Tₗᵢₘᵢₜ. This intelligent adaptability of the algorithm allows the control system to adjust itself to changing operating conditions in a particularly advantageous way.

Alternatively, a PID controller can be used, which is configured accordingly, so that a limit value control is realized with a parameterizable controller, by which t_{cool} is calculated individually depending on Tᵢₙₛₜ.

After tₘₑₐₛ and t_{cool} have elapsed, the opening valve 103 remains closed for the cycle pause time tₚₐᵤₛₑ. The cooling cycle then starts again. The total cycle time t_{cycle} is therefore the sum of tₘₑₐₛ, t_{cool} and tₚₐᵤₛₑ.

The respective cycle is thus simplified as follows and comprises the following sub-steps of:
c1) opening the opening valve 103 of the coolant supply system 100 to generate a flow of coolant through a cooling fluid system of the electric motor 8;
c2) measuring an instantaneous temperature of the coolant Tᵢₙₛₜ after a predetermined time tₘₑₐₛ has elapsed at the coolant discharge line 102 by the temperature measuring device 104 and transmission of the measured value for Tᵢₙₛₜ to a control apparatus 105, wherein the predetermined time tₘₑₐₛ is determined as a function of a length of the coolant discharge line 102 between the electric motor (8) and the temperature measuring device 104;
c3) comparing the measured value of Tᵢₙₛₜ with an upper limit value of the coolant temperature Tₗᵢₘᵢₜ;
c4) calculating a time t_{cool} by the control apparatus 105 as a function of Tᵢₙₛₜ, in which the opening valve 103 also remains open;
c5) closing the opening valve 103 after tₘₑₐₛ and t_{cool} have elapsed for a cycle pause time tₚₐᵤₛₑ;
whereupon the method steps c1) to c5) are run through again “virtually endlessly” in the manner of a program loop after tₚₐᵤₛₑ has elapsed until the drive motor of the centrifuge stops operating.

The method steps c1) to c5) are thus repeatedly run through with the aid of the control apparatus 105 or repeated in the manner of a loop, preferably until the operation of the drive motor is terminated. The program is then aborted.

The aim of the coolant temperature control according to the invention is to keep the instantaneous coolant temperature Tᵢₙₛₜ as constant as possible at Tₗᵢₘᵢₜ (manufacturer's specification). In this way, the electric motor 8 is operated at the maximum permissible temperature and with the lowest possible coolant consumption, regardless of its load and the temperature of the incoming coolant.

The electric motor manufacturer's specifications regarding the flow rate of the incoming coolant are generally static specifications for the rated load of the electric motor 8. For example, a flow rate of 3 l/min is specified for a maximum coolant temperature of 40° C. and a rated load of 37 kW.

In practice, such an operating point almost never occurs without coolant temperature control. Either the electric motor 8 is operated at partial load and/or the coolant supply temperature is lower than the maximum permissible. As a result, the electric motor 8 is generally supplied with more coolant per time than the operating situation of the electric motor 8 requires. The invention eliminates this deficiency in a simple manner.

A further advantage of this measuring and control arrangement is that it can be easily retrofitted to existing coolant-cooled electric motors, as only the temperature measuring device 104 at the coolant discharge line 102 needs to be added. A temperature sensor inside the electric motor 8 (e.g., in the coolant chamber) is not required. In addition, only a simple valve with two switching positions (“open” and “closed”) is required as the opening valve 103. Therefore, no control valve or controllable iris diaphragm is required, nor are several valves and lines, as in prior art solutions.

In FIG. 3, the coolant supply system 100 is designed according to the principle of a closed coolant circuit. This achieves a further reduction in coolant consumption. For this purpose, it is provided that the coolant is pumped in the circuit with the aid of a pump 106 and cooled with a heat exchanger 107. The required cooling capacity is supplied to the heat exchanger 107 via a cooling circuit 108.

In a further embodiment variant of the coolant supply system 100 according to FIG. 4, the coolant is taken from a storage tank 109 and pumped back into the storage tank 109 after flowing through the electric motor and absorbing heat. The heat absorbed by the coolant is released back into the surroundings of the storage tank 109 via a wall 110 of the storage tank 109, primarily by convection. The wall 110 of the storage tank 109 can be equipped with suitable means for improving convective heat dissipation, such as cooling fins. If the heat capacity of the coolant in the storage tank 109 and the heat dissipation via convection are not sufficient, coolant that is too hot can be drained via a first line 111 and cold coolant can be supplied via a second line 112.

The following application examples of the method according to the invention for monitoring and controlling the coolant temperature for the separator 1 show significant coolant savings with a coolant-cooled drive motor—here designed as a three-phase motor—for example with these performance data:

$$\begin{matrix}{P}_{ab} = 37 kW \\ {P}_{auf} = 40 kW\end{matrix}$$

Coolant flow rate: 3 l/min (manufacturer's specification) Maximum cooling water temperature: 40° C. (manufacturer's specification)

The parameters for the coolant control were as follows:
tₘₑₐₛ: 2 sec
t_{cool}: 2 sec
tₚₐᵤₛₑ: 6 sec
t_{cycle}: 10 sec

Experiment 1: (measurement after thermally stable operation)
Load: 35.9 kW
Coolant inlet temperature: 23.1° C.
Coolant outlet temperature: 40.8° C.
Coolant flow rate: 1.85 l/min
Temperature increase: 17.7K

Experiment 2: (measurement after thermally stable operation)
Load: 26.3 KW
Coolant inlet temperature: 23.5° C.
Coolant outlet temperature: 40.9° C.
Coolant flow rate: 1.73 l/min
Temperature increase: 17.4K

Advantageously, it has been shown that the coolant requirement can be kept to a minimum.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Separator
2 Drum
3 Hood arrangement
4 Drive spindle
5 Upper bearing
6 Lower bearing
7 Bearing housing
8 Electric motor
9 Motor housing
10 Stator
11 Rotor
12 Machine frame
13 Opening
14 Flange
15 Section
16 Opening
17 Damping element
18 Stepping
19 Stepping
20 Lubricant supply
100 Coolant supply system
101 Coolant supply line
102 Coolant discharge line
103 Opening valve
104 Temperature measuring device
105 Control apparatus
106 Pump
107 Heat exchanger
108 Refrigeration circuit
109 Storage tank
110 Wall
111 First line
112 Second line
113 Motor coolant passage
D Axis of rotation

1-15. (canceled)

16. A method comprising:
a) providing a centrifuge with a drive device of a rotor of the centrifuge, wherein the rotor has at least one rotatable drum, wherein the drive device has an electric motor that directly or indirectly rotates the rotor, and wherein the drive device further comprises a coolant supply system configured to supply the electric motor with a coolant;
b) driving the rotor with the electric motor; and
c) controlled cooling of the electric motor at least during step b) for a limited cooling phase in cooling cycles interrupted by breaks.

17. The method of claim 16, wherein a length of a respective cooling phase is determined by a control apparatus taking into account one or more measured values.

18. The method of claim 17, wherein the one or more measured values include one or more measured temperature values.

19. The method of claim 16, wherein the cooling cycles of step c) comprise the following sub-steps of:
c1) opening an opening valve of the coolant supply system to generate a flow of the coolant through a cooling fluid system of the electric motor, wherein the cooling fluid system comprises at least a coolant supply line, a coolant discharge line, and a motor coolant passage;
c2) measuring, at the coolant discharge line by a temperature measuring device, an instantaneous temperature of the coolant after a predetermined time has elapsed and transmitting measured value of the instantaneous temperature of the coolant to a control apparatus, wherein the predetermined time is determined as a function of a length of the coolant discharge line between the electric motor and the temperature measuring device;
c3) comparing the measured value of the instantaneous temperature of the coolant with an upper limit value of the coolant temperature;
c4) calculating, by the control apparatus as a function of the instantaneous temperature of the coolant, a time during which the opening valve also remains open; and
c5) closing the opening valve after the predetermined time and the calculated time during which the opening valve also remains open have elapsed for a cycle pause time,
wherein the method steps c1) to c5) are performed again in manner of a program loop after the cycle pause time has elapsed until the electric motor stops operating.

20. The method of claim 19, wherein, in step c5), the opening valve is closed immediately after the predetermined time period if the instantaneous coolant temperature is below an upper predetermined limit value of the coolant temperature.

21. The method of claim 20, wherein the opening valve remains open for a further time when the instantaneous coolant temperature is above the upper predetermined limit value of the coolant temperature.

22. The method of claim 16, wherein a correlation table of the measured values of the instantaneous temperature of the coolant and of the calculated time during which the opening valve also remains open is determined experimentally, resulting in a centrifuge or coolant supply system-specific characteristic curve representing a relationship between the measured values of the instantaneous temperature of the coolant and the calculated time during which the opening valve also remains open so that the coolant temperature control follows a characteristic curve control.

23. The method of claim 17, wherein the control apparatus is a PID controller.

24. The method of claim 19, wherein the control apparatus is supplied in step c) with one or more measured values of the instantaneous coolant temperature, whereupon the control apparatus uses the one or more measured values to determine a cooling time according to an algorithm, wherein if the coolant temperature does not change in a desired direction after several subsequent cooling cycles, the algorithm is adapted by the control apparatus until the coolant temperature adjusts to the upper limit value.

25. The method of claim 16, wherein the coolant supply system is a closed coolant circuit.

26. The method of claim 25, wherein the coolant is pumped in the closed coolant circuit by a pump and cooled with a heat exchanger, and wherein a required cooling capacity is supplied to the heat exchanger via a refrigeration circuit.

27. The method of claim 26, wherein the coolant is supplied by a storage tank and, after flowing through the electric motor and absorbing heat, the coolant is pumped back into the storage tank.

28. The method of claim 27, wherein the heat absorbed by the coolant is released again to surroundings of the storage tank by convection via a wall of the storage tank.

29. The method of claim 27, wherein when the coolant is too hot, the coolant is discharged from the storage tank via a first line and cold coolant is fed into the storage tank via a second line.
